(19) United States
(12) Patent Application Publication
(10) Pub. No.: US 2026/0343467 A1
(43) Pub. Date: Oct. 29, 2026

(54) PREVENTION OF ERROR PROPAGATION FOR SIDELINK POSITIONING

(71) Applicant: InterDigital Patent Holdings, Inc., Wilmington, DE (US)

(72) Inventors: Fumihiro Hasegawa, Westmount (CA); Tuong Duc Hoang, Montreal (CA); Tao Deng, New York, NY (US); Jaya Rao, Montreal (CA); Moon-il Lee, Melville, NY (US); Paul Marinier, Brossard (CA)

(73) Assignee: InterDigital Patent Holdings, Inc., Wilmington, DE (US)

(21) Appl. No.: 19/102,573

(22) PCT Filed: Aug. 8, 2023
(86) PCT No.: PCT/US2023/029745

§ 371 Date: Feb. 10, 2025

Related U.S. Application Data
(60) Provisional application No. 63/395,966, filed on Aug. 8, 2022.
(60) Provisional application No. 63/445,376, filed on Feb. 14, 2023.
(60) Provisional application No. 63/465,092, filed on May 9, 2023.

(51) Int. Cl. H04W 64/00; H04L 5/00; H04W 24/08; H04W 92/18

(52) U.S. Cl. CPC H04W 64/00; H04L 5/0048; H04W 24/08; H04W 92/18

(57) ABSTRACT

Systems, methods, and instrumentalities are disclosed for preventing error propagation for sidelink positioning. A target wireless transmit/receive unit (WTRU) may select one or more anchor WTRUs from candidate anchor WTRUs based on an uncertainty metric from the selected anchor WTRUs being below an error threshold. The target WTRU may determine a target WTRU absolute position and a target WTRU uncertainty metric. The target WTRU may determine the target WTRU absolute position using a default positioning method on a condition that the selected anchor WTRUs are below a threshold number of anchor WTRUs. The target WTRU may determine the target WTRU uncertainty metric, and the target WTRU uncertainty metric may include an uncertainty of the target WTRU and/or a degree of uncertainty of the target WTRU. The target WTRU may transmit, to a network node, an indication of the target WTRU absolute position and the target WTRU uncertainty metric.

### CROSS-REFERENCE TO RELATED APPLICATIONS

This application claims the benefit of U.S. Provisional Application No. 63/395,966, filed Aug. 8, 2022, U.S. Provisional Application No. 63/445,376, filed Feb. 14, 2023, and U.S. Provisional Application No. 63/465,092, filed May 9, 2023, the contents of which are incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are disclosed for preventing error propagation for sidelink positioning. A target wireless transmit/receive unit (WTRU) may select one or more anchor WTRUs from candidate anchor WTRUs based on an uncertainty metric from the selected anchor WTRUs being below an error threshold. The target WTRU may determine a target WTRU absolute position and a target WTRU uncertainty metric. The target WTRU may determine the target WTRU absolute position using a default positioning method on a condition that the selected anchor WTRUs are below a threshold number of anchor WTRUs. The target WTRU may determine the target WTRU uncertainty metric, and the target WTRU uncertainty metric may include an uncertainty of the target WTRU and/or a degree of uncertainty of the target WTRU. The target WTRU may transmit, to a network node, an indication of the target WTRU absolute position and the target WTRU uncertainty metric.

If the selected anchor WTRUs are below the threshold number of anchor WTRUs, the target WTRU uncertainty metric may be associated with an uncertainty of the default positioning method.

If the selected anchor WTRUs are above the threshold number of anchor WTRUs, the target WTRU may determine the target WTRU absolute position using a sidelink positioning method. If the selected anchor WTRUs are above the threshold number of anchor WTRUs, the target WTRU uncertainty metric may be associated with an uncertainty associated with the selected anchor WTRU and an uncertainty associated with the sidelink positioning method.

If the selected anchor WTRUs are equal to or above the threshold number of anchor WTRUs, the target WTRU may determine the target WTRU absolute position using a combination of the sidelink positioning method and the default positioning method.

The target WTRU may accumulate the uncertainty metric based on uncertainty metrics associated with each of the selected anchor WTRUs if the target WTRU absolute position is determined using the sidelink positioning method.

The target WTRU may reset the target WTRU uncertainty metric to an uncertainty associated with the default positioning method if the target WTRU absolute position is determined using the default positioning method.

The target WTRU may transmit, to the network node, information related to the selected anchor WTRUs used for positioning if the target WTRU enters network coverage. The information may include identification of the selected anchor WTRUs.

The target WTRU may receive configuration information indicating the default positioning method, the error threshold, and/or the threshold number of anchor WTRUs. The target WTRU may determine the candidate anchor WTRUs and the respective uncertainty metric from each of the candidate anchor WTRUs.

Systems, methods, and instrumentalities are disclosed for preventing error propagation for sidelink positioning. A wireless transmit/receive unit (WTRU) may determine, via a discovery procedure, anchor WTRUs. The WTRU may select, from the determined anchor WTRUs, a number of anchor WTRUs for positioning, and the number of anchor WTRUs may be determined by ranking the determined anchor WTRUs in descending order based on a respective priority level of the determined anchor WTRUs. The respective priority level of the determined anchor WTRUs may correspond to a respective category associated with the determined anchor WTRU. The WTRU may receive, from the selected anchor WTRUs, a respective positioning reference signal. The WTRU may determine a respective measurement corresponding to the respective positioning reference signal. The WTRU may report, to the network, the selected anchor WTRUs and the respective measurements.

The uncertainty metrics for the configured positioning methods may be further based on a location information uncertainty of the anchor WTRUs, assistance data of the anchor WTRUs, measurements of the anchor WTRUs, a number of anchor WTRUs, and/or a channel condition.

The configured positioning methods may include the following: Time Difference of Arrival (TDOA), Round Trip Time (RTT), Angle of Arrival (AoA), Angle of Departure (AoD), Global Navigation Satellite System (GNSS), sensor-based, and/or Wi-Fi-based.

Systems, methods, and instrumentalities are disclosed for preventing error propagation for sidelink positioning. A wireless transmit/receive unit (WTRU) may include one or more processors configured to obtain location uncertainty information of an associated anchor WTRU. Whether to select the anchor WTRU may be determined based on the location uncertainty information. In examples, the selection of the anchor WTRU may be based on the location uncertainty information being below a preconfigured uncertainty threshold. An accumulated uncertainty associated with the WTRU may be determined. In examples, the accumulated uncertainty may be a corresponding positioning error based on a determination that the WTRU determined the location of the WTRU without using an anchor WTRU. In examples, the accumulated uncertainty may be accumulated based on the determination that the WTRU determined the position of the WTRU using an anchor WTRU.

A WTRU may determine, via a discovery procedure, anchor WTRUs. The WTRU may select, from the determined anchor WTRUs, a number of anchor WTRUs for positioning. The number of anchor WTRUs may be determined by ranking the determined anchor WTRUs in descending order based on a respective priority level of each of the determined anchor WTRUs. The respective priority level of each of the determined anchor WTRUs may correspond to a respective category associated with each of the determined anchor WTRUs. The WTRU may receive, from each of the selected anchor WTRUs, a respective positioning reference signal. The WTRU may determine a respective measurement corresponding to each respective positioning reference signal. The WTRU may report, to the network, the selected anchor WTRUs and the respective measurements.

The WTRU may receive of be preconfigured with a list of anchor WTRUs. The list may identify a respective category for each anchor WTRU in the list. Each respective category may be associated with a respective priority.

The WTRU may receive, from the network, an indication of a positioning method. The WTRU may use the determination of the anchor WTRUs in the received positioning method.

A wireless transmit/receive unit (WTRU) may determine, via a discovery procedure, anchor WTRUs. The WTRU may select, from anchor WTRUs, positioning anchor WTRUs for a positioning method. The positioning anchor WTRUs may be determined in descending order based on priority levels, and the priority levels may correspond to categories associated with the positioning anchor WTRUs. The WTRU may receive, from the positioning anchor WTRUs, position reference signals. The WTRU may determine measurements corresponding to the position reference signals. The WTRU may report, to the network, the measurements and the positioning anchor WTRUs.

The WTRU may be preconfigured with a plurality of categories for the positioning anchor WTRUs, and each category of the plurality of categories may be associated with a priority level. The WTRU may receive, from the network, the positioning method.

Downlink, uplink, and downlink and uplink positioning methods may be used for positioning. Such methods may use signals (e.g., positioning reference signals, sounding reference signals, and sounding reference signals for positioning purposes). An environment may play a role (e.g., a critical role) in measuring signals, impacting positioning accuracy. In sidelink (SL) positioning, the position of the WTRU may be determined (e.g., by a target WTRU) based on measurements made on SL position reference signal (SL PRS) transmitted by an anchor WTRU. The position of the target WTRU may be determined (e.g., by the target WTRU) based on an absolute position(s) of the target WTRU(s) and a relative position of the target WTRU with respect to the position of the anchor WTRU (e.g., the location of the anchor WTRU).

The absolute position of a target WTRU (e.g., the WTRU to be positioned) may be determined using an absolute position of an anchor WTRU (e.g., a first anchor WTRU). Such a determination may include avoiding Uu positioning and such associated overhead or GNSS/GPS (e.g., the GNSS/GPS may consume power and time for accurate positioning).

The absolute position of a first anchor WTRU may be derived based on the absolute position of a second anchor WTRU. Error associated with the absolute position of the first and second anchor WTRU's absolute positions may propagate to the absolute position of the target WTRU.

An anchor WTRU may be selected (e.g., by the target WTRU) based on an estimated location uncertainty at the target WTRU (e.g., where the target WTRU may determine an estimated location error based on a location error uncertainty of the anchor WTRU measurements (e.g., using the reference signal received power (RSRP) and the reference signal time difference (RSTD)).

Location uncertainty information may include the uncertainty metric and/or the location uncertainty at the target WTRU. Location uncertainty information may be compared to a value, such as a threshold value. In examples, location uncertainty information may be above the preconfigured threshold. It may be determined (e.g., by the target WTRU) to use a default positioning method if the uncertainty is above the preconfigured threshold. The default positioning method may rely on GNSS/GPS and/or Uu positioning. The default positioning method may set the uncertainty (e.g., the location uncertainty) to the uncertainty of the GNSS/GPS positioning (e.g., the degrees of uncertainty may be set to zero (0)).

A first set of anchor WTRUs may be determined (e.g., by the target WTRU) based on a first metric (e.g., the degrees of uncertainty). Among the first set of WTRUs (e.g., anchor WTRUs), the target WTRU may determine the second set of anchor WTRUs based on a second metric (e.g., the uncertainty associated with the absolute position).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of error propagation.

FIG. 3 illustrates an example of a determination of a position of WTRUs with different degrees of uncertainty.

FIG. 4 illustrates an example of selecting anchor WTRUs based on the degree of uncertainty.

FIG. 5 illustrates an example signal flow diagram for a determination of anchor WTRUs.

FIG. 6 illustrates an example of selecting anchor WTRUS(s) for out-of-coverage.

### DETAILED DESCRIPTION

Systems, methods, and instrumentalities are described herein relating to the prevention of error propagation for sidelink positioning.

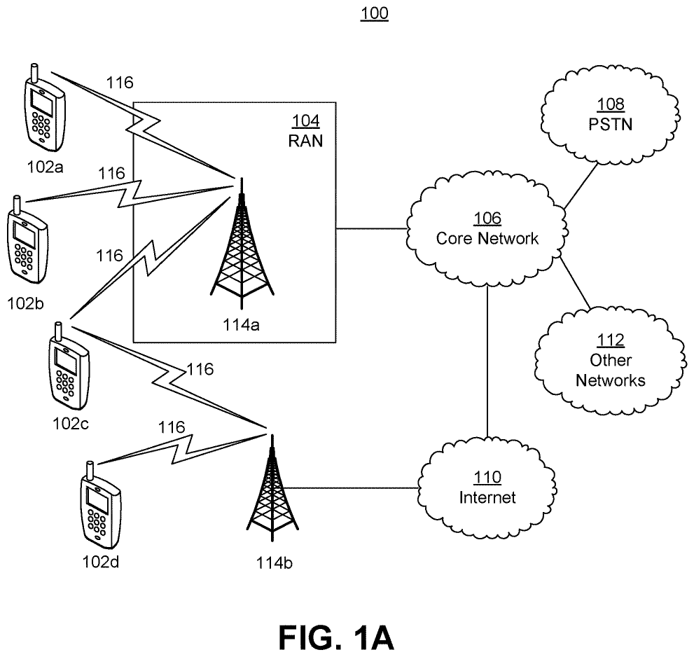

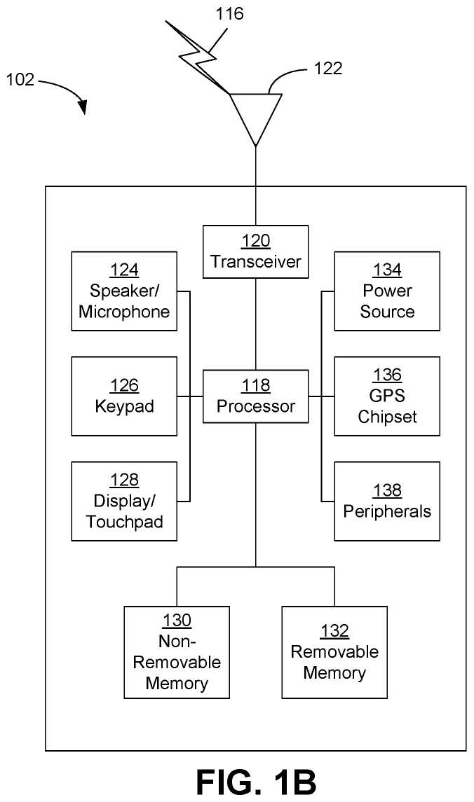

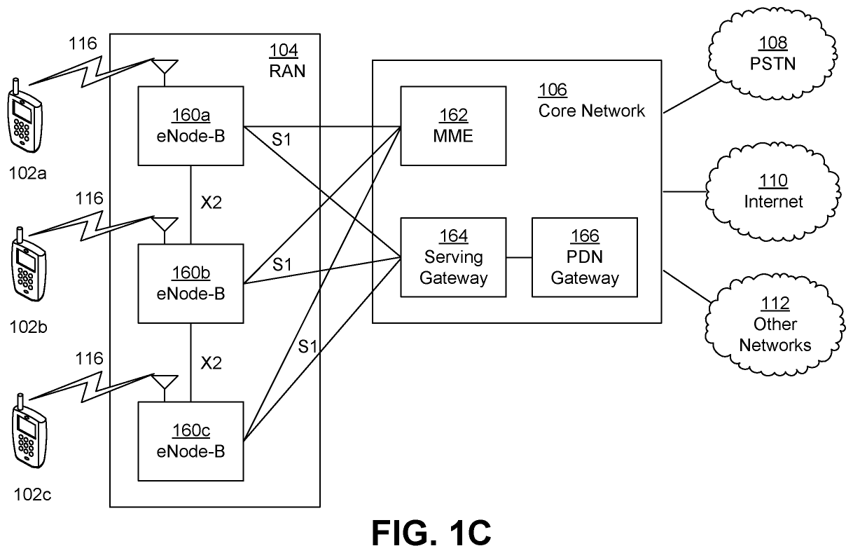

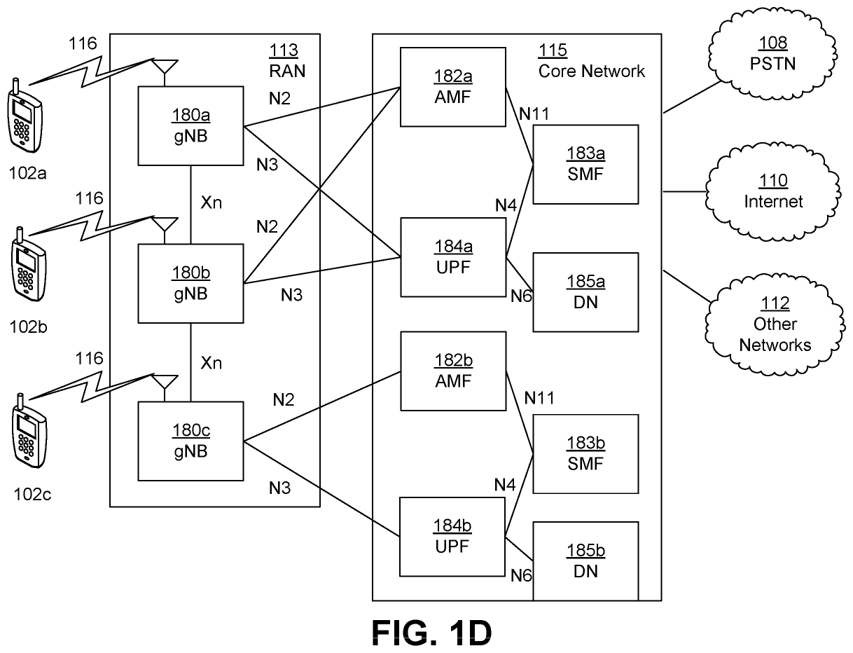

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. In examples, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. In examples, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. In examples, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. In examples, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. In examples, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. In examples, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. In examples, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). In examples, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. In examples, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. In examples, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. In examples, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. In examples, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. In examples, the CN 106 may provide the WTRUs 102a, 102b, 102c with access to circuit-switched networks, such as the PSTN 108, to facilitate communications between the WTRUs 102a, 102b, 102c and traditional land-line communications devices. In examples, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. In examples, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. In examples, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. In examples, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. In examples, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. In examples, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. In examples, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. In examples, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. In examples, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. In examples, the emulation devices may be used to test other devices and/or to simulate network and/or WTRU functions.

The emulation devices may be designed to implement one or more tests of other devices in a lab environment and/or in an operator network environment. In examples, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. In examples, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Configuration(s) referred to herein, such as configurations that are received at a WTRU, may refer to configuration information.

The description is provided for exemplary purposes and does not limit, in any way, the applicability of the methods described herein to other wireless technologies. The term network may refer to one or more gNBs, which may be associated with one or more transmission/reception points (TRPs), or to any other node in a radio access network (RAN).

A timing/angle positioning method may include a positioning method that uses reference signals (e.g., SL-PRS). Reference signals may be received (e.g., by the WTRU). RSTD, RSRP, and/or AoA may be measured (e.g., by the WTRU). In examples, angle/timing positioning methods may include SL-AoD or SL-TDOA positioning. SL-PRS may be transmitted (e.g., by and between the WTRU(s). A receiver may perform measurements (e.g., RSTD, AoA, RSRP) for determination of locations of the WTRU (e.g., the WTRU that transmitted the SL-PRS.)

An RTT positioning method may include a positioning method that may include two (2) WTRUs to transmit SL-PRS between one another. In examples, an anchor WTRU may transmit SL-PRS to a target WTRU. The target WTRU may receive SL-PRS from the anchor WTRU. The target WTRU may transmit SL-PRS to the anchor WTRU. The target WTRU may measure a WTRU Tx-Rx time delta (e.g., the difference between transmission time of SL PRS from the target WTRU and reception time of SL-PRS transmitted from the anchor WTRU. The target WTRU may report the WTRU Tx-RX time difference to the anchor WTRU.

Positioning methods described herein may be used to determine the relative location(s) of the target WTRU with respect to the anchor WTRU and/or the absolute position (e.g., the absolute position in terms of geographic coordinate systems or local coordinate systems).

Positions may be provided. In examples, an absolute position of the WTRU may be in terms of Geographical Coordinate Systems (GCS) or Local Coordinate Systems (LCS). In an example, a relative position of a target WTRU may be in terms of one or more of a distance from a second WTRU (e.g., anchor WTRU(s)), angle from a second WTRU (e.g., anchor WTRU(s), or reference point with a known location.

An SL-PRS configuration may include at least one or more of the following: SL-PRS resource ID, SL-PRS sequence ID (e.g., or other IDs used to generate SL-PRS sequence), SL-PRS resource element offset, SL-PRS resource slot offset, SL-PRS symbol offset, SL-PRS QCL information, SL-PRS resource set ID, list of SL-PRS resources in the resource set, number of SL-PRS symbols, muting pattern for SL-PRS, muting parameters such as repetition factor, muting options, SL-PRS resource power, periodicity of SL-PRS transmission, spatial direction information of SL-PRS transmission (e.g., beam information, angles of transmission), spatial direction information of SL-RS reception (e.g., beam ID used to receive SL-RS, angle of arrival), frequency layer ID, WTRU ID, SL-PRS ID.

A network may include one or more of an AMF, gNB, or NG-RAN. “Pre-configuration” and “configuration” may be used interchangeably herein. “Non-serving gNB” and “neighboring gNB” may be used interchangeably herein. “gNB” and “TRP” may be used interchangeably herein. “PRS” or “PRS resource” may be used interchangeably herein. “PRS(s)” or “PRS resource(s)” may be used interchangeably herein. The aforementioned “PRS(s)” or “PRS resource(s)” may belong to different PRS resource sets. “PRS” or “DL-PRS” or “DL PRS” may be used interchangeably herein. “Measurement gap” or “Measurement gap pattern” may be used interchangeably herein. “Measurement gap pattern” may include parameters (e.g., including measurement gap duration, measurement gap repetition period, and measurement gap periodicity).

A PRU may include a WTRU or TRP. The WTRU or TRP may include a location (e.g., an altitude, latitude, longitude, geographic coordinate, or local coordinate) that is known by the network (e.g., a gNB or LMF). The PRU may be the same (e.g., have the same capabilities) as a WTRU or TRP (e.g., capable of receiving PRS or transmitting SRS or SRS for positioning, return measurements, or transmitting PRS). WTRUs acting as PRUs may be used (e.g., used by the network) for calibration purposes (e.g., correct unknown timing offset, correct unknown angle offset).

An LMF may be a node or entity (e.g., a network node of entity) that may support positioning (e.g., may be used for or to support positioning). A node or entity may be substituted for an LMF.

Measurements may be obtained. The measurements may be associated with a position of a WTRU. In examples, an absolute position of a target WTRU (e.g., the WTRU to be positioned) may be determined using an absolute position of a second WTRU (e.g., a first anchor WTRU). Using an absolute position of a second WTRU may avoid Uu positioning and the associated overhead or GNSS/GPS which may consume power and time (e.g., for accurate positioning).

In examples, when the absolute position of the second WTRU is derived based on the absolute position of a second anchor WTRU, the error associated with the absolute position of the first and second anchor WTRU absolute positions may propagate to the absolute position of the target WTRU.

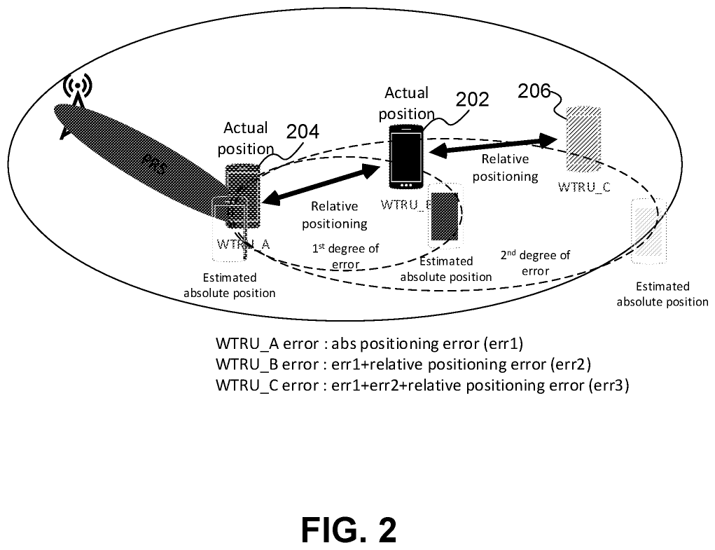

FIG. 2 illustrates an example of error propagation. In the example, the absolute position of the WTRU_B 202 may be determined (e.g., by the WTRU_B 202) based on the location information of the WTRU_A 204 and the relative position of the WTRU_B 202 with respect to the WTRU_A 204. If the location information of the WTRU_A 204 contains error, indicated by “err1” in the figure, the resulting accumulated uncertainty for the location of the WTRU_B 202 may become err1+err2, where err2 is the uncertainty related to relative position between the WTRU_B 202 and the WTRU_A 204. The absolute position of the WTRU_C 206 may be determined (e.g., by the WTRU_C 206) based on the absolute position of the WTRU_B 202. The accumulated uncertainty for the location of the WTRU_C 206 becomes err1+err2+err3 where err2 is the uncertainty related to relative position between the WTRU_C 206 and the WTRU_B 202 (e.g., if the absolute position of the WTRU_C 206 is determined by the WTRU_C 206 based on the absolute position of the WTRU_B 202).

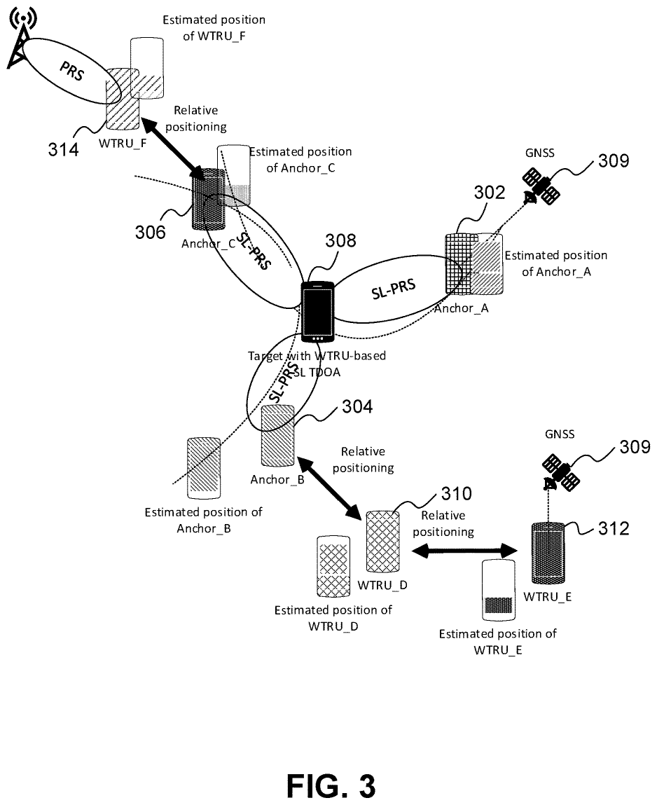

FIG. 3 illustrates an example of error propagation. Regarding error propagation, Anchor_A 302, Anchor_B 304, and Anchor_C 306 may be used (e.g., by the target WTRU for SL TDOA positioning 308). GNSS/GPS 309 may be used (e.g., by Anchor_A 302) for determination of the absolute position of Anchor_A 302. SL positioning may be used (e.g., by Anchor_B 304 with WTRU_D 310) to determine the absolute position of Anchor_B. GNSS/GPS may be used (e.g., by WTRU_E 312) for determination of the position of WTRU_E 312. The error associated with the absolute position (e.g., the absolute position of WTRU_F 314) may propagate to the absolute position of Anchor_B 304. The absolute position of Anchor_C 306 may be determined (e.g., by Anchor_C 306) based on SL positioning (e.g., SL positioning with WTRU_F 314). The absolute position of WTRU_F 314 may be determined (e.g., by WTRU_F 314) based on Uu positioning. Error associated with WTRU_F 314 may propagate to the absolute position (e.g., of Anchor_C 306). Different degrees of error may affect an anchor WTRU (e.g., the WTRUs). The accumulated error at an anchor WTRU may affect the accuracy of the absolute position of the target WTRU.

Location uncertainty information may be determined based on or may include one or more types of error. Location uncertainty, location uncertainty information, uncertainty metrics, and uncertainty may be used interchangeably herein. In examples, at least one of the following uncertainty metrics may be used (e.g., by the WTRU) to determine whether an anchor WTRU may be using SL positioning. In examples, a metric may include uncertainty with respect to the absolute position of the anchor WTRU. In examples, a metric may include a tier of uncertainty associated with the absolute position of the anchor WTRU. A tier of uncertainty (e.g., the tier associated with the absolute uncertainty associated with the absolute position of the anchor WTRU) may be a quantized uncertainty with respect to the absolute position of the anchor WTRU. An uncertainty metric may include degrees of uncertainty associated with the absolute position of the anchor WTRU, wherein the degree indicates how many times the original actual position has been referred to (e.g., to determine the current absolute position). An uncertainty metric may include an estimated uncertainty of the absolute position of the target WTRU.

For a type of error, the target WTRU may be configured with an error criterion (e.g., the degree of uncertainty may be less than a preconfigured threshold, uncertainty with respect to the absolute position of the anchor WTRU may be less than a preconfigured threshold) to determine whether the WTRU may be used for SL positioning.

Absolute position and relative position may be used interchangeably herein. In examples, a relative position may be defined as a position with respect to a reference node (e.g., a distance and angle with respect to a reference node).

In examples, if the target WTRU is in coverage of the network, a set of anchor WTRUs may be received (e.g., the target WTRU may receive a set of anchor WTRUs from the network). Assistance information may be received (e.g., the target WTRU may receive assistance information from the network associated with anchor WTRUs from the network regarding the absolute positions and uncertainty metrics). If the target WTRU is out of coverage of the network, a request for positioning may be sent (e.g., the target WTRU may send or broadcast a request for positioning to nearby WTRUs). The target WTRU may wait for a response from the anchor WTRU(s), and the presence of nearby anchor WTRUs (e.g., anchor WTRUs with whom the target WTRU performs SL positioning) may be determined (e.g., by the target WTRU). Assistance information associated with the anchor WTRU may be received (e.g., by the target WTRU) from an anchor WTRU (e.g., the assistance information may include the absolute positions and uncertainty metrics).

The WTRU may determine uncertainty information related to a location of the WTRU. The uncertainty related to an absolute position (e.g., of the target WTRU) may be defined as follows. The uncertainty related to an absolute position (e.g., of the target WTRU) may be expressed with respect to the absolute position (e.g., as a range). In examples, if the uncertainty of the horizontal position is ±2 m, and the estimated location on a horizontal axis is at 1.5 m from the origin, a possible location (e.g., of the target WTRU) may be between −0.5 m and 3.5 m.

A list of anchor WTRU(s) may be received (e.g., received by the WTRU from a network). Information related to the anchor WTRU(s) such as absolute position and its associated uncertainty may be received (e.g., received by the target WTRU). It may be determined (e.g., by the target WTRU) to use an anchor WTRU if uncertainty with respect to the absolute position (e.g., of the anchor WTRU) is less or equal to the preconfigured threshold.

An indication may be received (e.g., received by the target WTRU from the network) to find at least N anchor WTRU(s) to perform a positioning method (e.g., SL-TDOA). If the target WTRU cannot find N anchor WTRU(s), it may be determined (e.g., by the target WTRU) to perform a default positioning method (e.g., DL-TDOA or GNSS/GPS based positioning) that does not rely on anchor WTRU(s). If the default positioning method is not configured, it may be determined (e.g., determined by the WTRU) to send a request to an anchor WTRU and/or network (e.g., LMF, gNB) for a positioning method.

If N anchor WTRUs are found (e.g., by the target WTRU) whose location uncertainty is below the threshold, it may be determined (e.g., by the target WTRU) using the following examples.

In examples, it may be determined (e.g., determined by target WTRU) that the uncertainty of the position of the target WTRU is based on uncertainties (e.g., uncertainties of locations of anchor WTRUs). If more than one anchor WTRUs is used for positioning, uncertainty associated with the location of the target WTRU may be determined (e.g., by the target WTRU) to use a function to derive the overall uncertainty based on uncertainties (e.g., uncertainties for the absolute location of an anchor WTRU. Examples are described herein.

In examples, it may be determined (e.g., by the target WTRU) to accumulate uncertainties related to the location of an anchor WTRU. If it is determined (e.g., by the target WTRU) that the location of the target WTRU is based on PRSs transmitted from at least 3 anchor WTRUs and the ranges of uncertainties of the locations of the at least 3 anchor WTRU s are ±3 m, ±2 m, ±5 m, respectively, it may be determined (e.g., determined by the WTRU) that the uncertainty related to the location is 3+2+5=10 meters. Uncertainty based on measurement errors and uncertainty associated with time of arrival of SL-PRS, RSTD, AoA and/or AoD may be determined (e.g., by the WTRU).

In examples, an indication may be received (e.g., received by the target WTRU) to compute the uncertainty based on weights. In examples, weights may be determined (e.g., determined by the target WTRU) based on RSRP of SL-PRS received from anchor WTRU(s). It may be determined (e.g., by the WTRU) to compute the sum of RSRP and divide an RSRP by the sum (e.g., to obtain the weight). Based on weights, the WTRU may determine the uncertainty by applying a weight to an uncertainty.

In examples, the target WTRU may indicate which error source has an influence on the uncertainty (e.g., of the absolution position of the WTRU). The association between error sources and the absolute position of the target WTRU may be included in the assistance information provided to another target WTRU if the target WTRU becomes an anchor WTRU. The error source may include at least one or more of the following: error associated with absolute position of the anchor WTRU; measurement error (e.g., ToA, RSTD, RSRP, WTRU Tx-Rx time); LOS/NLOS indicator associated with measurements; transmission or reception timing error (e.g., at anchor WTRU or target WTRU); synchronization error (e.g., between anchor WTRU s, clock synchronization error).

Features described herein may include WTRU behavior (e.g., relating WTRU behavior) for determination of uncertainty of the WTRU location based on degrees of uncertainty.

The degrees of uncertainty may include the following. In examples, the degree of uncertainty may indicate the number of times the absolute position of an anchor WTRU is inherited. The degree of uncertainty may indicate how often (e.g., number of times) uncertainty has been associated with the absolute position that has been determined in the past. In examples, the degree of uncertainty may indicate how often (e.g., number of times) uncertainty has been added to the absolute position that has been determined (e.g., determined in the past).

An example of a determination of the degree of uncertainty may include the following. When it is determined (e.g., determined by the first target WTRU) to use the absolute position of the first anchor WTRU, a degree of uncertainty may be inherited (e.g., by the first target WTRU from the first anchor WTRU), and the degree of uncertainty may be incremented by one (1) count (e.g., the degree of uncertainty associated with the first target WTRU). When the first target WTRU becomes the second anchor WTRU, and second target WTRU determines to use the absolute position of the second anchor WTRU, the second target WTRU may inherit the degree of uncertainty of the second anchor WTRU and increments the degree by one (1) count. If the first anchor WTRU determines its position using a positioning method that does not require anchor WTRU(s), the first anchor may reset the degree of uncertainty to 0.

WTRUs with the zero degree of uncertainty may include a WTRU that determines the absolute position of the WTRU based on methods that do not rely on the absolute positions of anchor WTRUs (e.g., Uu positioning, sensor-based positioning, WiFi based positioning, and/or GNSS/GPS positioning). Such WTRUs may be a Road Side Unit (RSU) and/or Positioning Reference Unit (PRU).

In the example illustrated in FIG. 2, the degree of uncertainty at WTRU_C 206 is two (2) since the absolute position of WTRU_A 204 is inherited twice (e.g., once to WTRU_B 202 and the absolute position of WTRU_B 202 is inherited to WTRU_C 206).

If the absolute position (e.g., the absolute position of the target WTRU) is determined (e.g., determined by the target WTRU) to be based on more than one anchor WTRU(s) and the anchor WTRU(s) have different degrees of uncertainty, it may be determined (e.g., determined by the target WTRU) to perform at least one of the following for inheritance.

In examples (e.g., illustrated in FIG. 3), it may be determined to inherit the highest degree of uncertainty (e.g., the highest degree of uncertainty among the anchor WTRUs) and increment the degree by one. In examples, if the degree of uncertainty of anchor_A 302, anchor_B 304 and anchor_C 306 are 3, 5, 3, respectively, the target WTRU 308 may determine to set its degree of uncertainty to six (6).

In examples, it may be determined to compute the mean value of the degrees of uncertainty among the anchor WTRUs and increment the degree by one. In examples, if the degree of uncertainty of anchor_A, anchor_B and anchor_C are 3, 5, 3, respectively, the target WTRU may determine the average as ceil ((3+5+3)/3)+1=5 where ceil (x) is the ceiling function which rounds up x to the nearest integer.

In examples, it may be determined (e.g., by the target WTRU) to use an anchor WTRU for positioning based on the degree of uncertainty associated (e.g., the degree of uncertainty associated with the anchor WTRU). In examples, it may be determined (e.g., determined by the target WTRU) to use the anchor WTRU with the degree of uncertainty below the preconfigured threshold. In examples, an indication/configuration may be received (e.g., received by the target WTRU) from the network or anchor WTRU(s) with a threshold of one. Thus, it may be determined (e.g., by the target WTRU) to use anchor WTRUs with the degree of uncertainty equal to zero which may be RSU(s), PRU(s), gNB(s) and/or TRP(s). Alternatively, the WTRU may be configured to select only RSU, PRU, gNB and/or TRP as anchor WTRU(s) for determination of the absolute position of the WTRU via SL positioning and/or Uu positioning.

In examples, more than one uncertainty metrics (e.g., degrees of uncertainty, uncertainty associated with the absolute position) may be used (e.g., by the target WTRU). In examples, it may be determined (e.g., by the target WTRU) to use both degree of uncertainty and uncertainty for the absolute position (e.g., of the anchor WTRU) to determine whether to use an anchor WTRU (e.g., for positioning). In examples, it may be determined (e.g., by the target WTRU) to use the anchor WTRU for positioning if one or more of the following are satisfied: the degree of uncertainty associated with the anchor WTRU is below the first threshold; and/or uncertainty associated with the absolute position of the anchor WTRU is below the second threshold.

An anchor WTRU(s) may be selected (e.g., by the target WTRU) for SL positioning based on the tier or level of uncertainty associated with the error(s) associated with the absolute uncertainty of the anchor WTRU(s). The error tier may present a level of error, indicating how large the error is, and the error tier may also be a quantized uncertainty of the absolute position.

In examples, an error tier one 1 may indicate that the error is low while an error tier 3 may indicate that a large error may be present. A tier may include a range of error. In examples, the error tier 1may include an error below one (1) meter. Tier 2 may include an error greater than or equal to one (1) meter and less than three (3) meters, for example. The absolute position (e.g., of the anchor WTRU) may be associated with the error tier. It may be determined (e.g., determined by the target WTRU) to select an anchor WTRU with the error tier below the preconfigured threshold.

When the absolute position is determined (e.g., determined by the target WTRU), the error associated with the position may be determined (e.g., determined by the target WTRU) based on the associated uncertainty. The error tier may be determined (e.g., determined by the target WTRU) based on at least one or more of the following. Uncertainty associated with the absolute position of the target WTRU may be used to determine the error tier. In examples, a mapping table may be received (e.g., received by the WTRU from the network and/or anchor WTRU) where a row has a range of uncertainty for the absolute position. The positioning method may be used to determine the error tier. In examples, it may be determined (e.g., determined by the WTRU) that the error tier is increased by a certain amount (e.g., for a positioning method). In examples, if a TDOA positioning method is used, the tier level may be incremented by one. Uncertainty in measurements may be used to determine the error tier (e.g., time of arrival, RSRP, multipath measurements). The number of anchor WTRUs may be used to determine the error tier. In examples, if the number of anchor WTRUs used for positioning is greater than a preconfigured threshold, it may be determined (e.g., determined by the WTRU) to increase the tier level by one (1).

In examples, if more than one anchor WTRUs is used for positioning, the WTRU determines its own tier level as follows. Using uncertainties associated with the absolute positions of the anchor WTRUs, the target WTRU determines the uncertainty associated with the target WTRU's absolute position first. Using the mapping table, the target WTRU determines its tier where the mapping table indicates ranges of uncertainty and corresponding error tier. In examples, the error tier one is defined as an uncertainty below 1 meter. Tier 2 is defined as the uncertainty greater than or equal to one (1) meter and less than three (3) meters, for example. Tier 3 is defined as the uncertainty greater than three (3) meters but less than or equal to five (5) meters.

In examples, it may be determined (e.g., by the WTRU) to select a set of anchor WTRU(s) for SL positioning based on the estimated error associated with the absolute position of the target WTRU. The target WTRU may determine the estimated error based on the assistance information the target WTRU may have received from anchor WTRU(s) and/or network (e.g., LMF, gNB).

A set of anchor WTRUs may be selected (e.g., by the target WTRU) based on or more of the following conditions: a preconfigured list (e.g., provided by anchor WTRU(s) or the network), channel conditions (e.g., SSB/SL reference signal RSRP associated with the anchor WTRU is above a preconfigured threshold); or an LOS/NLOS condition (e.g., LOS indicator between the target WTRU and anchor WTRU is above a preconfigured threshold).

Anchor WTRUs may be selected (e.g., by the target WTRU) up to N WTRUs where N may be the number of WTRUs required for a configured positioning method.

Based on the selected anchor WTRU(s), estimated error may be determined (e.g., by the target WTRU) based on one or more of the following. Estimated error may be determined based on uncertainty associated with the absolute position(s) (e.g., of the anchor WTRU(s). In examples, the WTRU may determine to accumulate the uncertainty associated with the absolute position(s) of the anchor WTRU(s). Estimated error may be determined based on a range of measurements (e.g., range of time of arrival, RSTD, RSRP) associated with an anchor WTRU. In examples, if the positioning method uses RSTDs, the estimated error may be determined (e.g., determined by the WTRU) based on a mapping function which may map ranges of RSTDs to uncertainties of the absolute position of the target WTRUs. Estimated error may be determined based on an expected value of measurements (e.g., expected time of arrival, expected RSTD, expected RSRP). Estimated error may be determined based on a positioning method. In examples, the WTRU may be configured with a TDOA-based SL positioning method with a set of anchor WTRUs. Uncertainty associated with the absolute position of the target may be determined (e.g., determined by the WTRU) based on the outcome of the positioning method.

In examples, an indication (e.g., from the network (e.g., LMF, gNB) may be received (e.g., by the target WTRU) indicating which uncertainties to use for determination of the estimated error. In examples, the WTRU may determines the estimated error based on a combination of the aforementioned uncertainties. In examples, the WTRU determines the estimated error as a summation of the uncertainty of the absolute position of the target WTRU derived from the positioning method and uncertainties associated with absolute positions of the anchor WTRU(s) used for the positioning method. The target WTRU may use a configured function. The configured function may include a summation, multiplication, or weighed summation.

In examples, if the estimated error is below the preconfigured threshold, it may be determined (e.g., by the target WTRU) to use the set of anchor WTRU(s) associated with the estimated error (e.g., the estimated error for SL positioning). If the estimated error is above or equal to the preconfigured threshold, it may be determined (e.g., determined by the target WTRU) to select another set of anchor WTRU(s) and determines the estimated error. If no more anchor WTRU(s) may be selected (e.g., by the target WTRU), it may be determined (e.g., by the target WTRU) to implement the default positioning method (e.g., Uu positioning, GNSS/GPS based positioning). If the WTRU is not configured with the default positioning, a request may be sent (e.g., by the WTRU) to anchor WTRU(s) or the network for configuration of a positioning method.

In the examples described herein, “estimated uncertainty” may be used interchangeably with “estimated degrees of uncertainty” or “estimated error tier.”

A combination of selection criteria may be associated with a selection of a WTRU (e.g., an anchor WTRU).

In examples, a configuration related to the priority level of the uncertainty may be received (e.g., by the WTRU) to use for determination of the anchor WTRU(s) to use for SL positioning. In examples, an indication may be received (e.g., from the network and to the WTRU) to use the degree of uncertainty at higher priority than the uncertainty associated with the absolute positioning of the anchor WTRU.

In examples, an order of uncertainty for selection of anchor WTRUs may be received (e.g., by the target WTRU). In examples, the first set of anchor WTRUs may be selected (e.g., by the target WTRU) based on the degree of uncertainty. Based on the determined first set of anchor WTRUs, the second set of anchor WTRUs may be determined (e.g., by the target WTRU) based on uncertainties associated with their absolute position(s).

In examples, it may be determined (e.g., by the WTRU) to select a set of anchor WTRUs based on criteria for uncertainty and measurements. In examples, the first set of anchor WTRUs and uncertainty information related to their absolute positions may be received (e.g., by the WTRU from the network). A configuration from the network may be received (e.g., by the WTRU) to determine anchor WTRUs based on the degrees of uncertainty. Two thresholds may be received (e.g., by the WTRU), the first threshold for RSRP of SL reference signals and the second threshold for the degrees of uncertainty. The RSRP of SL reference signal resources from anchor WTRUs may be measured (e.g., by the WTRU). If the RSRP of the SL reference signal for at least one resource from an anchor WTRU is above the first threshold, it may be determined (e.g., by the target WTRU) to use the anchor WTRU for SL positioning if the degree of uncertainty corresponding to the anchor WTRU is above a threshold. If the RSRP is below the first threshold, it may be determined (e.g., by the target WTRU) to select the anchor WTRU if the associated degree of uncertainty is below the second threshold.

Up to N anchor WTRU(s) may be associated with a target WTRU.

In examples, the target WTRU may be configured with N, the maximum number of anchor WTRUs to choose for SL positioning. M anchor WTRUs may be selected (e.g., by the target WTRU), where M<N based availability of anchor WTRUs may satisfy the uncertainty criterion. In examples, it may be determined (e.g., by the target WTRU) to select M anchor WTRUs since the degrees of uncertainty associated with their absolute position is lower than the preconfigured threshold. It may be determined (e.g., by the target WTRU) which positioning method to use based on an available number of anchor WTRUs. In examples, the target WTRU may be preconfigured with a table associating the number of available anchor WTRUs and the positioning method the target WTRU may use. In examples, the table may indicate that if N anchor WTRUs are available, SL-TDOA may be used by the target WTRU. If there are less than N anchor WTRUs available, the table may indicate that the target WTRU may use an RTT-based positioning method.

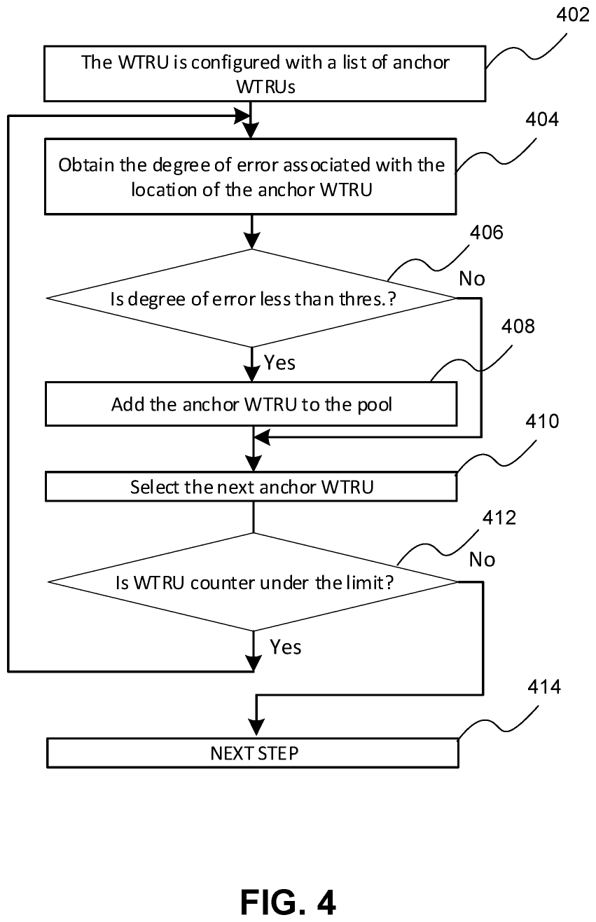

An example of the flowchart (e.g., of the target WTRU's selection of anchor WTRUs based on the degrees of uncertainty) is shown in FIG. 4. In the example, at 402, a list of anchor WTRUs may be received (e.g., by the target WTRU and from the network). At 404, a degree of error associated with the absolute location of the anchor WTRU may be obtained (e.g., by the target WTRU). At 406, if the degree of error is less than the threshold, the target WTRU may add the anchor WTRU to the pool at 408. At 410, the next anchor WTRU in the list may be selected (e.g., by the target WTRU). At 412, if the counter for the anchor WTRU is under the limit, the search may be continued (e.g., by the target WTRU) at 414.

Fallback behavior may be associated with using a default criterion (e.g., criteria).

In examples, a configuration of the fallback uncertainty criterion may be received (e.g., by the WTRU). In examples, if an indication from the network is received (e.g., by the WTRU) to use the degree of uncertainty at a higher priority than the uncertainty associated with the absolute positioning of the anchor WTRU, but the degree of uncertainty associated with the absolute position of the anchor WTRU is not available, it may be determined (e.g., by the WTRU) to use the default criterion (e.g., uncertainty for the absolute position) to determine an anchor WTRU(s) to use for SL positioning.

If requested (e.g., by the network), a report (e.g., from the WTRU) may be sent (e.g., to the network) including one or more of: absolute position; uncertainty metric(s) associated with the absolute position (e.g., uncertainty, degrees of uncertainty); information related to anchor WTRU(s), e.g., WTRU ID; and measurements (e.g., RSRP, RSTD, ToA) used to determine the absolute position where measurements may be associated with PRS resource ID(s), PRS resource set ID(s).

Features described herein may involve a validity related to uncertainty.

Uncertainty metric(s) (e.g., degrees of uncertainty), may have validity associated with such uncertainty metric(s). Examples of validity may include one or more of: area validity, wherein it may be determined (e.g., by a WTRU) that uncertainty metrics for the target WTRU and/or anchor WTRUs may be valid within an area (e.g., cell ID); and, time validity, wherein it may be determined (e.g., by a WTRU) that uncertainty metrics may have an expiration time. A timer may be started, and it may be determined (e.g., by the WTRU) to update the uncertainty metrics (e.g., when the timer expires).

In examples, when an uncertainty metric(s) associated with an absolute position is not valid, it may be determined (e.g., by the WTRU) to update the uncertainty metric(s) following one or more of the following: if the default positioning method (e.g., GNSS/GPS based positioning) is configured (e.g., by the network), the default positioning method may be performed (e.g., by the WTRU), and the uncertainty metric(s) associated with the positioning method may be obtained; and, if the default positioning method is not configured, a request may be sent (e.g., by the WTRU to the network) to initiate positioning.

A quality determination (e.g., that is WTRU-based/based on the WTRU) of an anchor WTRU may be made (e.g., by the target WTRU).

In examples, a request may be sent (e.g., by the WTRU to the network and/or anchor WTRU(s)) for positioning. The network and/or anchor WTRU(s) may not know the accuracy requirement for the target WTRU, since the request may originate from the target WTRU. A list of anchor WTRU(s) available for positioning (e.g., to the target WTRU) may be provided (e.g., by the network). The request may be responded to (e.g., by the anchor WTRU(s)) and assistance information (e.g., SL-PRS configuration information, absolute position, uncertainty metric(s) associated with the absolute position) may be sent (e.g., by the anchor WTRU to the target WTRU). A list of anchor WTRU(s) may be received (e.g., by the target WTRU from the network) based on prior knowledge (e.g., of the network of the location or approximate location of the target WTRU.

A selection of anchors WTRUs may be prioritized.

A target WTRU may determine an anchor WTRU based on the category the anchor WTRU belongs to and/or a priority level associated with the category, where characteristics about the location information of the anchor WTRU may be categorized.

If the target WTRU is out-of-coverage, the WTRU may determine anchor WTRU(s) based on the coverage status of anchor WTRU(s) and/or how a location of the anchor WTRU(s) are determined. In examples, the target WTRU may be configured by the network (e.g., gNB, LMF) or peer WTRU (e.g., a WTRU with LMF capability) with a priority level associated with characteristics about location information of the anchor WTRUs. In examples, the WTRU may select anchor WTRU(s) based on the priority level. The WTRU may be preconfigured with a list of categories by the network (e.g., gNB, LMF) or peer WTRU (e.g., a WTRU with LMF capability), where a category may consist of characteristics of anchor WTRU location information. A priority level may be associated with a category. The target WTRU may determine the priority level for a category based on a configuration (e.g., via LPP, RRC, MAC-CE, DCI) from the network/peer WTRU.

In examples, an anchor WTRU may belong to one or more of the following example categories.

Category 1: an anchor WTRU is in-coverage, its location is determined via GNSS, and its location is verified by the network. Category 2: an anchor WTRU is out-of-coverage, its location is determined via GNSS, and its location is verified by the network. A roadside unit or positioning reference unit may belong to this category. Category 3: an anchor WTRU is in-coverage, its location is determined via a RAT dependent positioning method (e.g., DL-TDOA, RTT, DL-AD, UL-AoA, UL-TDOA), and its location is verified by the network. Category 4: an anchor WTRU is in-coverage, its location is determined via GNSS, and its location is not verified by the network. Category 5: an anchor WTRU is in-coverage, its location is determined via a RAT dependent positioning method (e.g., DL-TDOA, RTT, DL-AOD, UL-AoA, UL-TDOA), and its location is not verified by the network. Category 6: an anchor WTRU is out-of-coverage, its location is determined via GNSS, and its location is not verified by the network. Category 7: an anchor WTRU is out-of-coverage, its location is determined via a RAT dependent positioning method, and its location is not verified by the network.

Category 1 may be associated with a higher priority than categories 2-7. Category 7 may be associated with the lowest priority (e.g., lower than categories 1-6). If, via a discovery process, the target WTRU discovers more than one anchor WTRU(s), the target WTRU may determine the category of an anchor WTRU and determine a subset of WTRU(s) based on a priority associated with the category. In examples, if the target WTRU is out-of-coverage, the WTRU may determine, based on the determined positioning method (e.g., via configuration, default/present configuration, hard coded in specification), that four anchor WTRUs are (e.g., are required) for a positioning method. The target WTRU may discover seven anchor WTRUs, where two WTRUs belong to category 1, one WTRU belongs to category 3, one WTRU belongs to the category 4, two WTRUs belong to the category 6, and one WTRU belongs to the category 7. If the priority level is associated in a descending order with respect to category number (e.g., category 1 has the highest priority and the category 7 has the lowest priority), the WTRU may determine to select the two WTRUs in category 1, one WTRU in category 3, and one WTRU in category 4.

If the target WTRU selects (e.g., needs to select) anchor WTRU(s) from a same category, the WTRU may determine the anchor WTRU based on anchor WTRU IDs (e.g., choose the anchor WTRU from the smallest WTRU ID). The WTRU may select anchor WTRUs based on an indication from the network.

The WTRU may discover potential anchor WTRUs according to one or more of the following.

A list of anchor WTRUs may be provided by the network or peer WTRU (e.g., WTRU with LMF capability) via unicast/groupcast/broadcast. In examples, the target WTRU may provide its location (e.g., cell/area ID, location estimated by GNSS or RAT dependent positioning method) to the network, and the WTRU may receive a list of anchor WTRUs which are within the threshold from the reported location of the target WTRU.

A discovery process may be performed by the target WTRU. In examples, the target WTRU may perform a discovery procedure and identify anchor WTRUs with location information (e.g., a coordinate of the anchor WTRU, a cell/area ID of a cell/area the anchor WTRU belongs to).

The WTRU may determine from the discovered/configured anchor WTRU(s) (e.g., via higher layer message such as RRC, SCI, SL MAC-CE, NAS message, SLPP message) at least one of the following.

The WTRU may determine a WTRU ID of the anchor WTRU. The WTRU may determine location information (e.g., a coordinate of the WTRU according to GCS/LCS, cell/area ID/index that the anchor WTRU is located in) of the anchor WTRU. The WTRU may determine an uncertainty of location information of the anchor WTRU. The WTRU may determine a positioning method used to determine location information of the anchor WTRU. The WTRU may determine whether location information of the anchor WTRU is verified by the network. In examples, the anchor WTRU may need to report its location and/or measurements to the network to verify its location. An indicator may be used to indicate whether the location of the anchor WTRU is verified (e.g., indicator=1) or not (e.g., indicator=0).

The WTRU may determine whether location information of the anchor WTRU has been determined based on verified location(s) or partially verified location(s), where a partial verification may be expressed numerically (e.g., 50% verified, 100% verified, where the percentage may be determined based on a positioning method and/or based on how many WTRUs with verified locations have been used in positioning). In examples, using a scenario illustrated in FIG. 3, if the location of WTRU_E 312 (determined by GNSS 309) is verified by the network, and the location of WTRU_D 310 (determined by relative positioning) is not verified by the network, the target WTRU 308 may determine that the location of Anchor_B 304 is partially verified. In examples, using a scenario illustrated in FIG. 3, if the locations of WTRU_E 312 and WTRU_D 310 are verified by the network, the target WTRU 308 may determine that a location of Anchor_B 304 is determined based on verified locations. The location of Anchor_B 304 may be verified if the target WTRU 308 determines, according to indication/configuration from the network, that Anchor_B 304 does not need to perform verification with the network. If the location of the anchor WTRU is determined based on a mixture of anchor WTRU(s) whose locations are either verified or not verified, the target WTRU may determine that the location of the anchor WTRU is partially verified. An indicator may be used to indicate whether the location of the anchor WTRU is determined based on verified WTRUs (e.g., indicator=1) or not (e.g., indicator=0).

The WTRU may determine coverage status of the anchor WTRU (e.g., in coverage, out-of-coverage). The WTRU may determine degrees/tiers of uncertainty of location information of the anchor WTRU.

Whether the location of the anchor WTRU for RAT dependent positioning methods is verified or not may depend on whether a WTRU-assisted or WTRU-based positioning method is used by the network/anchor WTRU. In examples, if the anchor WTRU makes measurements (e.g., RSTD, ToA, AoA, AOD) on DL PRS and reports the measurements to the network, the network may determine the location of the anchor WTRU, and the determined location may be verified by the network. If the anchor WTRU performs a WTRU-based positioning method, the anchor WTRU may need to send the determined location and corresponding measurements (e.g., measurements made on the received PRS) to the network for verification. The category may include information about whether a WTRU-based positioning method (e.g., WTRU-based DL-TDOA, WTRU-based DL-AoD) or WTRU-assisted positioning method (e.g., WTRU-assisted DL-TDOA, WTRU-assisted DL-AOD, RTT, UL-AoA, UL-TDOA) was performed to determine the WTRU location.

In examples, a priority level associated with a category may depend on the coverage status of the target WTRU. If the target WTRU is in in-coverage, category 3 may have a higher priority than category 2, as described herein.

In categories described herein, the WTRU location information may not be verified by the network. Information on whether verification on the WTRU location was performed may be omitted from the category.

Determination of WTRU location in an above category (e.g., a category where WTRU location information is not verified, and/or a category where the anchor/target WTRU location is to be determined) may be replaced by accuracy (e.g., range of an error in location estimate expressed in terms of distance unit such as meters, standard deviation of location estimate, variance of location estimate). The category may include accuracy information in addition to the information elements described in the categories described herein.

In categories described herein, mobility of an anchor WTRU (e.g., anchor may be mobile or stationary) may be included.

A category may consist of one or more of the following information.

A category may include uncertainty of location information of the anchor WTRU. A category may include a positioning method used to determine location information (e.g., WTRU-assisted/WTRU-based).

A category may include whether location information of the anchor WTRU is verified by the network/entity (e.g., external location server). The anchor WTRU may report its location and/or measurements to the network to verify its location. An indicator may be used to indicate whether the location of the anchor WTRU is verified (e.g., indicator=1) or not (e.g., indicator=0).

A category may include whether location information of the anchor WTRU has been determined based on verified location(s) or partially verified location(s). Partial verification may be expressed numerically (e.g., 50% verified, 100% verified; a percentage may be determined based on a positioning method and how many WTRUs with verified locations have been used in positioning). In examples, using an example illustrated in FIG. 3, if the location of WTRU_E (determined by GNSS) is verified by the network, and the location of WTRU_D (determined by relative positioning) is not verified by the network, the target WTRU may determine that the location of Anchor_B is partially verified. In examples, using the scenario illustrated in FIG. 2, if the locations of WTRU_E and WTRU_D are verified by the network, the target WTRU may determine that a location of Anchor_B is determined based on verified locations. The location of Anchor_B may be verified if the target WTRU determines, according to indication/configuration from the network, that Anchor_B does not perform verification with the network. If the location of the anchor WTRU is determined based on a mixture of anchor WTRU(s) whose locations are verified and not verified, the target WTRU may determine that the location of the anchor WTRU is partially verified. An indicator may be used to indicate whether the location of the anchor WTRU is determined based on verified WTRUs (e.g., indicator=1) or not (e.g., indicator=0).

A category may include coverage status of the anchor WTRU (e.g., in coverage, out-of-coverage). A category may include degrees/tier of uncertainty. A category may include mobility status (mobile or stationary). A category may include a type of the WTRU (e.g., a PRU/RSU/WTRU with LMF capability.

An example may include the following. A WTRU may be preconfigured with a list of categories for anchor WTRUs, where category from the list of categories may be associated with a priority level. The WTRU may be configured with a positioning method (e.g., SL-TDOA) from the network. Via a discovery procedure, the WTRU may determine anchor WTRUs. The WTRU may determine the required number of anchor WTRUs for the positioning method. The anchor WTRUs may be selected in descending order of priority level according to the categories the anchor WTRUs belong to (e.g., anchor WTRU(s) in a category with a higher priority may be selected). The WTRU may make measurements on SL-PRS(s) transmitted by the anchor WTRUs, and the WTRU may report the selected anchor WTRUs and measurements to the network.

It may be determined (e.g., by the target WTRU) to reset or improve uncertainty associated with the absolute position (e.g., of the target WTRU) based on conditions.

Uncertainty may be reduced via a default positioning method.

In examples, it may be determined (e.g., by the target WTRU) to reduce uncertainty associated with the position (e.g., of the WTRU) if one or more of the following are satisfied: uncertainty associated with the absolute position (e.g., of the target WTRU) may be higher than a preconfigured threshold; and/or an indication is received (e.g., by the target WTRU from the network) to improve uncertainty.

If one or more of the aforementioned are satisfied, it may be determined (e.g., by the WTRU) to perform the default positioning method (e.g., GNSS), and the absolute position and associated uncertainty metric(s) (e.g., of the WTRU) may be determined (e.g., by the WTRU). If the default positioning method does not lower the uncertainty associated with the absolute position, a request may be sent (e.g., by the WTRU to the network) to remove the WTRU from the list of anchor WTRUs.

It may be determined (e.g., by a target WTRU) to reduce the degree of uncertainty with the position (e.g., of the target WTRU) if one or more of the following are satisfied. In examples, the degree of uncertainty or error tier associated with the absolute position of the target WTRU may be higher than the preconfigured threshold. In examples, an indication may be received (e.g., by the target WTRU from the network) to lower the degree of uncertainty (e.g., or error tier).

If one or more of the aforementioned is satisfied, it may be determined (e.g., by the WTRU) to perform the default positioning method (e.g., GNSS/GPS) or a (e.g., any) positioning methods that do not rely on anchor WTRUs. After performing the positioning method, the degree of uncertainty may be set to zero (0), or the error tier may be reset (e.g., by the WTRU) to the value associated with the positioning method.

A reduction of uncertainty may be via on-demand.

In examples, if the target WTRU is in coverage, if one or more of the aforementioned is satisfied, it may be determined (e.g., by the WTRU) to send a request (e.g., to the network and/or anchor WTRU(s)) to configure a set of anchor WTRU(s) or an anchor WTRU (e.g., for SL positioning). A set ID and/or WTRU ID(s) may be indicated (e.g., by the WTRU) in the request.

A set ID and/or WTRU ID may be indicated (e.g., by the target WTRU to the network). If there are no more sets of WTRUs or WTRUs to request, it may be determined (e.g., by the target WTRU) to perform the default positioning method (e.g., GNSS/GPS positioning).

In examples, If there are no (e.g., no more) sets of WTRUs or WTRUs to request, a request (e.g., from the target WTRU to the network and/or anchor WTRU(s)) may be sent for another set of SL-PRS configurations (e.g., wider bandwidth, shorter periodicity, larger number of slots that contain SL-PRS). If the new set of configurations is received (e.g., by the target WTRU from an anchor WTRU(s) and/or network), it may be determined (e.g., by the target WTRU) to perform a positioning method (e.g., with the initial set of anchor WTRUs).

In examples, if the target WTRU is out of coverage, the WTRU may send another request for positioning to a different WTRU. If the target WTRU cannot find any more WTRUs within a preconfigured time window, the target WTRU may determine to perform the default positioning method (e.g., GNSS/GPS positioning). In examples, the target WTRU may start a timer and searches for a different anchor WTRU until the timer expires. The WTRU may receive the expiration time for the timer.

The positioning method used may be reported. In examples, if requested by the network or peer WTRU (e.g., a WTRU with LMF capability), the target WTRU may report to the network (e.g., LMF, gNB) or peer WTRU (e.g., WTRU with LMF capability) the positioning method used to determine its location (e.g., the location of the target WTRU). If the target WTRU determined to use GNSS to determine its location, the target WTRU may indicate to the network that GNSS was used to determine the location of the target WTRU.

The uncertainty associated with the WTRU location may be determined. In examples, the WTRU (e.g., a target WTRU) may determine uncertainty associated with the WTRU location based on a function of configuration and/or assistance data associated with anchor WTRU(s) (e.g., uncertainty associated with location information of anchor WTRU(s)). The WTRU may determine an uncertainty of its location as a function of uncertainty of anchor WTRU(s)' location information, assistance data, measurements (e.g., RSRP, RSTD, ToA, WTRU Rx-Tx time), number of anchor WTRUs, channel condition (e.g., LOS indicator), and/or positioning method used to determine the WTRU's location. If a TDOA like positioning method is used, the uncertainty metric for the determined WTRU location may be the average of uncertainty metrics for anchor WTRUs. If an RTT like positioning method is used, the uncertainty metric for the determined WTRU location may be an output of a nonlinear function of uncertainty metrics for anchor WTRUs.

Parameters related to an uncertainty metric may be used to determine whether an amount is below or above a threshold. As described herein, uncertainty below a threshold may refer to at least one of the following: an error tier is below a configured threshold; degrees of uncertainty are below a configured threshold; and/or a maximum and/or minimum value of the uncertainty metric is below a configured threshold. An example for uncertainty below a configured threshold may be as follows: if the uncertainty metric is defined by a range (e.g., +/−5 m), the maximum (e.g., 5 m), minimum (e.g., −5 m), or absolute value of the maximum value of the range (e.g., 5 m) is below a configured threshold.

A positioning method may be determined based on uncertainty. In examples, the WTRU may determine anchor WTRUs to be used for a positioning method via a discovery process. The WTRU may receive assistance information (e.g., an uncertainty metric) from anchor WTRUs. Based on the uncertainty metrics of anchor WTRUs, the WTRU may determine uncertainty metrics for configured positioning method(s) (e.g., RAT dependent positioning methods such as TDOA, RTT, AoA, AoD positioning methods, or RAT independent positioning method such as GNSS, sensor-based, wifi-based positioning). Based on the determined uncertainty metric for a positioning method, the WTRU may determine to use the positioning method with the minimum or smallest uncertainty metric. In examples, the WTRU may determine uncertainty metrics for the positioning method as a function of uncertainty of anchor WTRU(s)' location information, assistance data, and/or number of anchor WTRUs.

In examples, if the WTRU is configured with a TDOA positioning method and GNSS, the WTRU may determine the uncertainty metric associated with the TDOA positioning method based on uncertainty metrics of locations of anchor WTRUs. The WTRU may determine an uncertainty metric associated with the GNSS positioning method. The WTRU may choose the TDOA positioning method if an uncertainty metric associated with the TDOA method is smaller than the uncertainty metric associated with the GNSS positioning method.

After the WTRU determines the positioning method, the WTRU may determine an uncertainty metric associated with the determined WTRU location information.

In examples, the number of anchor WTRUs discovered for a positioning method may be greater than the number (e.g., a required number) of anchor WTRUs for the positioning method. The number (e.g., required number) of anchor WTRUs for the positioning method may be configured by the network or peer WTRU (e.g., the WTRU with the LMF capability). In examples, if the number of discovered anchor WTRUs is greater than the number (e.g., required number) of anchor WTRUs (e.g., N) for a positioning method, the WTRU (e.g., target WTRU) may determine to select N anchor WTRUs based on at least one of the following metrics, e.g., priority level (e.g., high, low, medium, a number between 0 and 1) associated with the anchor WTRU, distance of the anchor WTRU with respect to the WTRU, RSRP of signals (e.g., SL-PRS) transmitted from the anchor WTRU (e.g., choose N anchor WTRUs with N highest RSRP values), coverage status (e.g., prioritize selection of anchor WTRUs in coverage over anchor WTRUs in out of coverage), anchor WTRUs with verified location where the location is verified by the network or peer WTRU (e.g., server WTRU where the WTRU can act as an LMF by configuring SL-PRS to other WTRUs determining location information of other WTRUs based on measurements, receive location information from other WTRUs, the server WTRU may configure SL-PRS to WTRUs based on preconfigured SL-PRS, etc.), anchor WTRUs that are verified or indicated by the network or peer WTRU (e.g., server WTRU), and/or mobility status (e.g., prioritize selection of anchor WTRUs which are stationary or low mobility over anchor WTRUs that are in high mobility). In examples, the WTRU (e.g., target WTRU) may send identities of discovered anchor WTRUs (e.g., RNTI, WTRU ID) to the network or peer WTRU (e.g., server WTRU) and ask for indication of N anchor WTRUs from the network or peer WTRU.

The WTRU may include a determination of a default positioning method. The default positioning method may be incorporated in a tarted WTRU. The target WTRU may be configured to select one or more anchor WTRUs from candidate anchor WTRUs. The selection criteria may be based on an uncertainty metric from the selected anchor WTRUs being below an error threshold.

In examples, a configuration (e.g., a default positioning method, SL positioning method, threshold, or N (e.g., a required number of anchor WTRUs) may be received (e.g., by a WTRU from a network). Configuration information of the configuration may indicate the default positioning method, the error threshold, and/or the threshold number of anchor WTRUs. The target WTRU may be enabled to determine candidate anchor WTRUs and a respective uncertainty metric from the candidate anchor WTRUs. The target WTRU may determine an anchor WTRU based on the response for request for positioning. The target WTRU may receive PRS configurations and error information (e.g., location uncertainty) from the anchor WTRU(s). The PRC location uncertainty information may be used by the target WTRU to determine a target WTRU absolute position and a target WTRU uncertainty metric.

If the selected anchor WTRUs are above the threshold number of anchor WTRUs, the target WTRU may determine the target WTRU absolute position using a sidelink positioning method. Under these conditions, the target WTRU uncertainty metric may be associated with an uncertainty associated with the selected anchor WTRU and an uncertainty associated with the sidelink positioning method.

When the selected anchor WTRUs are equal to or above the threshold number of anchor WTRUs, the processor may determine the target WTRU absolute position using a combination of the sidelink positioning method and the default positioning method.

The WTRU may select the anchor WTRUs if the associated location uncertainty is below the preconfigured error threshold. If N anchor WTRUs are not found (e.g., by the WTRU), it may be determined (e.g., by the WTRU) to use the default positioning method (e.g., GNSS) to determine the absolute position (e.g., of the WTRU).

If at least N anchor WTRUs are found (e.g., by the WTRU), the preconfigured positioning method may be performed, and the absolute position may be determined. Accumulated uncertainty may be determined (e.g., by the WTRU) based on or more of the following. If the position is determined (e.g., by the WTRU) without using anchor WTRUs (e.g., GNSS), the accumulated error may be reset to the corresponding positioning error (e.g., GNSS); The target WTRU may reset the target WTRU uncertainty metric to an uncertainty associated with the default positioning method on a condition that the target WTRU absolute position is determined using the default positioning method.

If the position is determined (e.g., by the WTRU) using anchor WTRUs, the error may be accumulated. The WTRU may accumulate the uncertainty metric based on a uncertainty metrics associated with the selected anchor WTRUs, provided that the target WTRU absolute position is determined using the sidelink positioning method.=

If the WTRU is in-coverage, a report may be sent (e.g., by the WTRU to the network) containing the absolute position, associated uncertainty metrics and information related to anchor WTRUs (e.g., WTRU IDs) used for SL positioning (e.g., if the WTRU enters in-coverage or the WTRU is in coverage). The target WTRU may be configured to transmit, to the network node, an indication of the target WTRU absolute position and the target WTRU uncertainty metric. The target WTRU may transmit, to the network node, information related to the selected anchor WTRUs used for positioning when the target WTRU enters network coverage. The transmitted information may include identification of the selected anchor WTRUs.

Different uncertainty metrics may be associated with a determination of anchor WTRUs.

In examples, PRS configurations related to anchor WTRUs may be received (e.g., by the WTRU) with associated error information (e.g., location uncertainty, degrees of uncertainty), first and second error threshold, N (required number of anchor WTRUs) and positioning method(s) (e.g., from a network (e.g., LMF, gNB)). A first set of anchor WTRUs may be received (e.g., by the WTRU from the network). A prioritization list of uncertainties (e.g., degrees of uncertainty higher than location uncertainty) may be received (e.g., by the WTRU). Based on the first set of anchor WTRUs, the second set which may include WTRUs with the degrees of uncertainty (e.g., lower than the first threshold) may be determined (e.g., by the WTRU). If the number of WTRUs in the second set is lower than N, it may be determined (e.g., by the WTRU) to perform the default positioning method (e.g., GNSS, Uu based positioning). Based on the second set of anchor WTRUs, the third set which may include WTRUs with the uncertainty lower than the second threshold may be determined (e.g., by the WTRU). If the number of WTRUs in the third set is lower than N, it may be determined (e.g., by the WTRU) to perform the default positioning method (e.g., GNSS, Uu based positioning). An SL positioning method may be performed, and the absolute position of the WTRU may be determined (e.g., by the WTRU). Uncertainty metrics associated with the absolute position may be determined (e.g., by the WTRU). If the WTRU is in-coverage, a report containing the absolute position and associated uncertainty metrics and a set of anchor WTRUs (e.g., WTRU IDs) used to determine the position of the WTRU may be sent (e.g., by the WTRU).

Measurements and uncertainty metrics may be associated with a determination of anchor WTRUs.

In examples, a request for location information may be received (e.g., by a WTRU from the network). PRS configurations related to anchor WTRUs may be received (e.g., by the WTRU) with associated error information (e.g., degrees of uncertainty), first and second error threshold, N (required number of anchor WTRUs) and positioning method(s) (e.g., from the network (e.g., LMF, gNB)). The first set of anchor WTRUs may be received (e.g., by the WTRU from the network). Measurements (e.g., RSRP) may be made (e.g., by the WTRU) relating to SL PRSs transmitted (e.g., from the set of anchor WTRUs). If RSRP measured on SL-PRS for an anchor WTRU is above or equal to the first threshold, it may be determined (e.g., by the WTRU) to use the anchor WTRU for SL positioning. If RSRP measured on SL-PRS for the anchor WTRU is below the first threshold, and an uncertainty metric associated with the absolute position of the anchor WTRU is below the second threshold, it may be determined (e.g., by the WTRU) to use the anchor WTRU for SL positioning. The position may be determined (e.g., by the WTRU) based on SL positioning. If more than one anchor WTRU is used for SL positioning, the degree of uncertainty associated with the absolute position may be determined (e.g., by the WTRU) based on the maximum degree of uncertainty (e.g., among anchor WTRUs). A set of anchor WTRUs (e.g., WTRU IDs) used to determine the position of the WTRU may be reported (e.g., by the WTRU), along with the absolute position of the WTRU and associated uncertainty metric(s) (e.g., degrees of uncertainty).

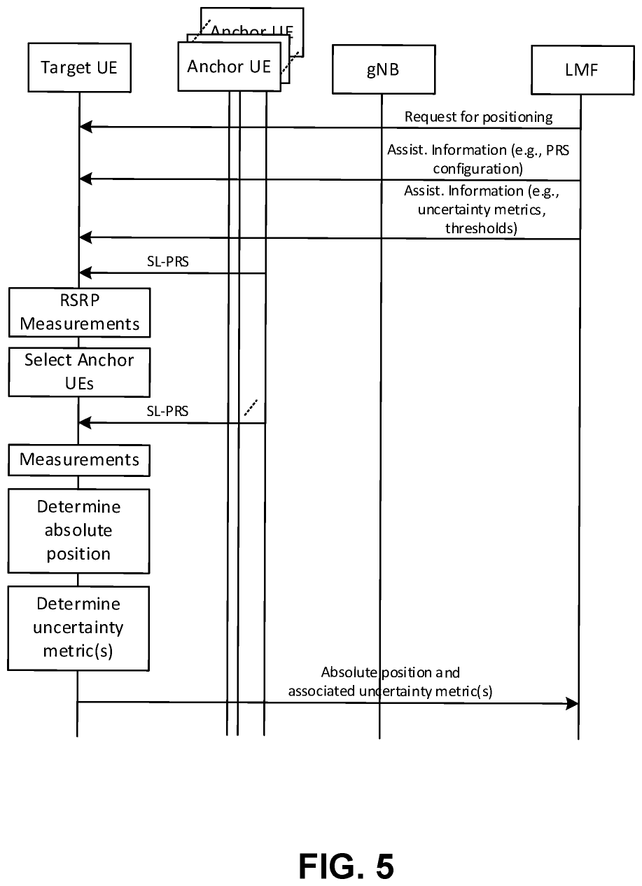

FIG. 5 illustrates an example signal flow diagram that may be applied to the determination of anchor WTRUs based on measurements and uncertainty metrics.

An out-of-coverage scenario may be associated with a determination of anchor WTRUs.

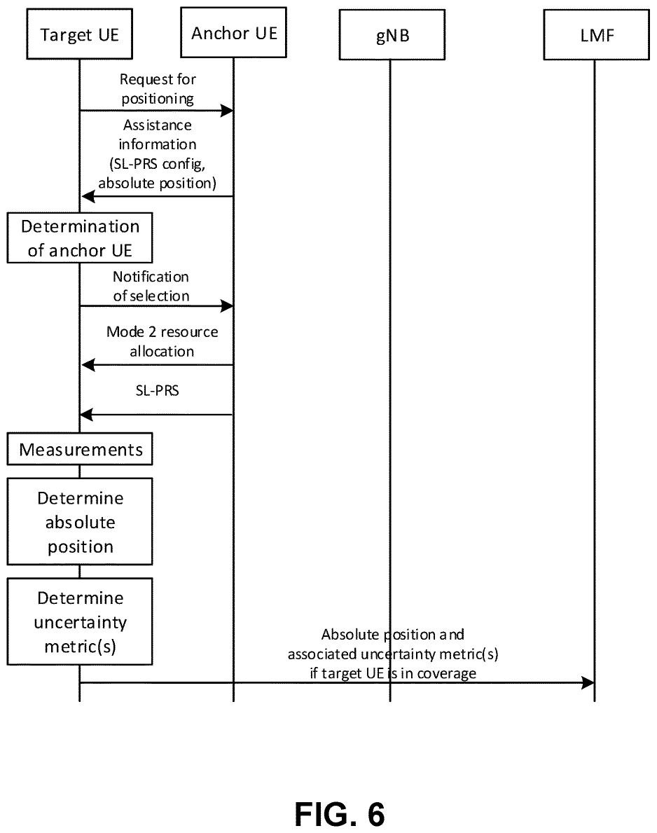

FIG. 6 illustrates an example of a selection of anchor WTRU(s) for an out-of-coverage scenario.

In examples, a positioning method and selection criteria (e.g., degrees of uncertainty lower than the threshold) for anchor WTRU(s) may be preconfigured (e.g., on a target WTRU). An anchor WTRU may be discovered (e.g., by the target WTRU), and a request for positioning may be sent (e.g., by the target WTRU). Assistance information may be received (e.g., by the target WTRU from the anchor WTRU). It may be determined (e.g., by the target WTRU) to use the anchor WTRU based on the degree of uncertainty associated with the absolute position (e.g., of the anchor WTRU). If the degree of uncertainty is above the threshold, a different anchor WTRU may be searched for (e.g., by the target WTRU) until the search timer expires. A notification of selection may be sent (e.g., by the target WTRU to the anchor WTRU). Resource allocation information (e.g., for SL-PRS) may be received (e.g., by the target WTRU from the anchor WTRU) (e.g., mode 2 allocation, indicating time and/or frequency resources used for SL-PRS transmission). Measurements (e.g., relating to SL-PRS) may be made (e.g., by the target WTRU). The absolute position of the target WTRU may be determined (e.g., by the target WTRU) based on measurements (e.g., measurements made on SL-PRSs sent by anchor WTRU(s). Uncertainty metric(s) based on uncertainty metric(s) associated with absolute position(s) of anchor WTRU(s) may be determined (e.g., by the target WTRU). If the target WTRU enters coverage, the absolute position (e.g., of the target WTRU) and associated uncertainty metric(s) and information related to anchor WTRU(s) used for SL positioning may be returned.

Although features and elements are described above in particular combinations, one of ordinary skill in the art will appreciate that each feature or element can be used alone or in any combination with the other features and elements. In addition, the methods described herein can be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software can be used to implement a radio frequency transceiver for use in a WTRU, UE, terminal, base station, RNC, or any host computer.

1-18. (canceled)

19. A first wireless transmit/receive unit (WTRU) comprising a processor:
the processor configured to:
send, to a second WTRU, a request that includes a request for a sidelink positioning reference signal (SL-PRS) sequence identifier (ID) of the second WTRU and a position of the second WTRU; and
receive, from the second WTRU, a response indicating the SL-PRS sequence ID of the second WTRU, a periodicity of SL-PRS transmission, ID information of the second WTRU, the position of the second WTRU, and an uncertainty of the position of the second WTRU.

20. The first WTRU of claim 19, wherein a second WTRU uncertainty metric is based on the uncertainty of the position of the second WTRU.

21. The first WTRU of claim 20, wherein the processor is further configured to transmit, to a network node, an indication of the position of the second WTRU and the second WTRU uncertainty metric.

22. The first WTRU of claim 20, wherein the processor is further configured to determine the second WTRU uncertainty metric based on the periodicity of SL-PRS transmission.

23. The first WTRU of claim 20, wherein the processor is further configured to determine the second WTRU uncertainty metric based on an uncertainty range associated with the position of the second WTRU.

24. The first WTRU of claim 19, wherein the processor is further configured to receive, from the second WTRU, assistance information associated with the second WTRU, the assistance information comprising one or more of an absolute position of the second WTRU or an uncertainty metric associated with an absolute position of the second WTRU.

25. The first WTRU of claim 19, wherein the first WTRU comprises a target WTRU, and wherein the second WTRU comprises an anchor WTRU.

26. A method for a first wireless transmit/receive unit (WTRU), wherein the method comprises:
sending, to a second WTRU, a request that includes a request for a sidelink positioning reference signal (SL-PRS) sequence identifier (ID) of the second WTRU and a position of the second WTRU; and
receiving, from the second WTRU, a response indicating the SL-PRS sequence ID of the second WTRU, a periodicity of SL-PRS transmission, ID information of the second WTRU, the position of the second WTRU, and an uncertainty of the position of the second WTRU.

27. The method of claim 26, wherein a second WTRU uncertainty metric is based on the uncertainty of the position of the second WTRU.

28. The method of claim 27, wherein the method further comprises transmitting, to a network node, an indication of the position of the second WTRU and the second WTRU uncertainty metric.

29. The method of claim 27, wherein the method further comprises determining the second WTRU uncertainty metric based on the periodicity of SL-PRS transmission.

30. The method of claim 27, wherein the method further comprises determining the second WTRU uncertainty metric based on an uncertainty range associated with the position of the second WTRU.

31. The method of claim 26, wherein the method further comprises receiving, from the second WTRU, assistance information associated with the second WTRU, the assistance information comprising one or more of an absolute position of the second WTRU or an uncertainty metric associated with an absolute position of the second WTRU.

32. The method of claim 26, wherein the first WTRU comprises a target WTRU, and wherein the second WTRU comprises an anchor WTRU.
